(19) United States
(12) Patent Application Publication
(10) Pub. No.: US 2019/0176656 A1
(43) Pub. Date: Jun. 13, 2019

(54) APPARATUS AND METHOD FOR DETERMINING VEHICLE PERFORMANCE FACTORS

(71) Applicant: JAGUAR LAND ROVER LIMITED, COVERTRY (GB)

(72) Inventors: THOMAS OSGOOD, Warwickshire (GB); NAVNEESH PHILLIP, Warwickshire (GB); KRZYSZTOF KOBYLINSKI, Warwickshire (GB); IONUT GHEORGHE, Warwickshire (GB)

(21) Appl. No.: 16/204,744

(22) Filed: Nov. 29, 2018

(30) Foreign Application Priority Data
Dec. 8, 2017 (GB) 1720465.2

(51) Int. Cl. B60L 58/12; G07C 5/00; G07C 5/08; G01C 21/36

(52) U.S. Cl. CPC B60L 58/12; G07C 5/008; B60L 2260/54; G01C 21/3697; G07C 5/085

(57) ABSTRACT

A method of determining operating factors of a second vehicle based on sensor data received relating to a plurality of journeys taken in a first vehicle can include: receiving sensor data relating to a plurality of journeys of the first vehicle; determining a predicted energy consumption of a second vehicle for each of a plurality of journeys undertaken by the first vehicle using the received sensor data; determining a predicted routine energy consumption profile of the second vehicle from the predicted energy consumption for each of the plurality of journeys; and generating an output for displaying the one or more operating factors indicative of a charging requirement for the second vehicle to a user, wherein the output is based on the predicted routine energy consumption profile.

### CROSS REFERENCE TO RELATED APPLICATION

This application claims priority to and the benefit of GB Patent Application No. 1720465.2 filed Dec. 8, 2017, the content of which is incorporated herein by reference in its entirety.

### TECHNICAL FIELD

The present disclosure relates to an apparatus and method for determining one or more operating factors of a vehicle in dependence on sensor data received relating to journeys taken in another vehicle. Aspects of the invention relate to an apparatus, to a method, to a computer program product, to a mobile computing device and to a computer readable storage medium.

### BACKGROUND

Drivers of petrol or diesel vehicles may consider transitioning to using a hybrid or electric vehicle for many reasons, for example due to environmental concerns. However many drivers have concerns regarding the transition. For example, some drivers may be concerned about how operating factors of the electric vehicle and how such operating factors may fit into their current lifestyle.

It is currently difficult for potential electric vehicle users to determine whether an electric vehicle would be suitable for them.

At least in certain embodiments, the present invention seeks to mitigate or overcome at least some of the above-mentioned problems.

### SUMMARY

Aspects and embodiments of the invention provide an apparatus, a method, a computer program product, a mobile computing device and a computer readable storage medium as claimed in the appended claims.

In accordance with the an aspect of the invention, there is provided an apparatus for determining one or more operating factors of a second vehicle in dependence on sensor data received relating to a plurality of journeys taken in a first vehicle. The apparatus comprises an input configured to receive the sensor data relating to the plurality of journeys taken in the first vehicle and a processing means. The processing means is configured to determine a predicted energy consumption of a second vehicle for each of a plurality of journeys undertaken by the first vehicle using the received sensor data, determine a predicted routine energy consumption profile of the second vehicle from the predicted energy consumption for each of the plurality of journeys and generate an output for conveying the one or more operating factors indicative of a charging requirement for the second vehicle to a user, wherein the output is dependent on the predicted routine energy consumption profile.

In embodiments the sensor data is obtained by a user device present within the first vehicle during the plurality of journeys. The apparatus may include the user device.

The second vehicle may be an electric vehicle. The electric vehicle may comprise a battery electric vehicle (BEV), or a hybrid electric vehicle, such as a plug-in hybrid electric vehicle (PHEV), or a mild hybrid electric vehicle (MHEV), for example.

The charging requirement may include one or more of how often the second vehicle would need to be charged, how long each charge event would be required to last to provide sufficient charge in accordance with the predicted routine energy consumption and/or the position of relevant charging stations.

In embodiments, the processing means may be configured to determine the type of charging means available to a given user in dependence on the predicted routine energy consumption profile. For example, certain types of charging means may be available at given charging locations determined to be relevant to the determined predicted routine energy consumption profile. In some embodiments, the processing means may be configured to determine how long each charge event would be required to last to provide sufficient charge in dependence on the type of charging means available at one or more relevant charging stations.

In embodiments, the processing means may be configured to receive position data relating to charging stations for the second vehicle and using the predicted routine energy consumption profile and position data to determine a charging profile of the second vehicle. In embodiments, the position data relating to charging stations may comprise information relating to the location of existing available charging locations. In such embodiments, the processing means may be configured to retrieve this information from a database of charging locations. Additionally or alternatively, the processing means may be configured to determine the position data relating to charging stations in dependence on a user input indicative of a location of a charging station, or a proposed location of a charging station, e.g. where a user may be considering installing a charging station were they to purchase the second vehicle.

The sensor data may comprise data relating to locations of the first vehicle during each of the plurality of journeys. For example, the sensor data is generated by one or more sensors upon receipt of GNSS data. The GNSS data may be received automatically by the one or more sensors during the plurality of journeys. The GNSS data may include GPS, GLONASS, Galileo, BDS, NAVIC or QZSS data.

According to another aspect of the invention, there is provided a method of determining one or more operating factors of a second vehicle in dependence on sensor data received relating to a plurality of journeys taken in a first vehicle. The method comprises receiving sensor data relating to a plurality of journeys of the first vehicle. The sensor data is obtained by a user device present within the first vehicle during the journeys. The method comprises determining a predicted energy consumption of a second vehicle for each of a plurality of journeys undertaken by the first vehicle using the received sensor data and determining a predicted routine energy consumption profile of the second vehicle from the predicted energy consumption for each of the plurality of journeys. The method comprises generating an output for conveying the one or more operating factors indicative of a charging requirement for the second vehicle to a user, wherein the output is dependent on the predicted routine energy consumption profile.

The second vehicle may be an electric vehicle, which may be a battery electric vehicle (BEV), a plug-in hybrid electric vehicle (PHEV), or a mild hybrid electric vehicle (MHEV), for example.

The conveying of the one or more operating factors could include displaying the one or more operating factors on a user interface or screen of the user device and/or transmitting an audio message of the operating factors.

The user device could be a mobile computing device such as a smartphone, tablet, smart watch or laptop.

The charging requirement may include how often the second vehicle would need to be charged, how long each charge event would be required to last to provide sufficient charge in accordance with the predicted routine energy consumption and/or the position of relevant charging stations.

In embodiments, the method may comprise determining the type of charging means available to a given user in dependence on the predicted routine energy consumption profile. For example, certain types of charging means may be available at given charging locations determined to be relevant to the determined predicted routine energy consumption profile. In some embodiments, the method may comprise determining how long each charge event would be required to last to provide sufficient charge in dependence on the type of charging means available at one or more relevant charging stations.

The sensor data may comprise data relating to locations of the first vehicle during each of the plurality of journeys. For example, the sensor data is generated by one or more sensors upon receipt of GNSS data. The GNSS data may be received automatically by the one or more sensors during the plurality of journeys. The GNSS data may include GPS, GLONASS, Galileo, BDS, NAVIC or QZSS data.

In embodiments, the GNSS data is received automatically during the plurality of journeys.

The method may comprise receiving position data relating to charging stations for the second vehicle and using the predicted routine energy consumption profile and position data to determine a charging profile of the second vehicle. In embodiments, the position data relating to charging stations may comprise information relating to the location of existing available charging locations. This information may be retrieved from a database of charging locations. Additionally or alternatively, the position data relating to charging stations may be determined in dependence on a user input indicative of a location of a charging station, or a proposed location of a charging station, e.g. where a user may be considering installing a charging station were they to purchase the second vehicle.

The method may comprise storing and/or receiving energy storage means data associated with the second vehicle and using the energy storage means data to determine the predicted energy consumption. The energy storage means may be a battery, fuel cell, engine and/or fuel tank of the vehicle. The energy storage means data may include temperature performance data of an energy storage means of the second vehicle.

In embodiments, the method comprises receiving temperature data associated with the plurality of journeys, the energy storage means data including temperature performance data.

In embodiments, the temperature performance data includes predicted auxiliary energy usage for maintaining the temperature of the energy storage means at a predetermined temperature, or for heating or cooling the energy storage means of the second vehicle to the predetermined temperature. The method may comprise including the determined predicted auxiliary energy usage in the predicted energy consumption of the second vehicle.

The method may comprise determining one or more positions where the first vehicle is most frequently parked and/or routes along which the first vehicle most frequently travels and determining relevant charging stations within a driving profile area, the driving profile area being within a predetermined radius of the frequently parked positions and/or frequently travelled routes.

Determining the one or more positions may include receive an input from the user.

The method may comprise updating the predicted routine energy consumption after each subsequent journey in the first vehicle.

The present invention also provides a computer program product comprising instructions which, when the program is executed by a computer, cause the computer to carry out the method as described in relation to any of the embodiments above and a mobile computing device having stored thereon the above described computer program product.

The present invention also provides a non-transitory computer-readable medium comprising instructions which, when executed by a computer, cause the computer to carry out the method as described in relation to any of the embodiments above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a flowchart illustrating a method for determining the compatibility of an electric vehicle with a user's usage pattern in accordance with an embodiment of the invention;

FIG. 2 is a schematic representation of a route taken by a vehicle and determined from a plurality of data points;

FIG. 3 is a flow chart illustrating a method for determining a route taken by a vehicle;

FIGS. 4a-4d show graphs relating to motion data relating to a route taken by a vehicle;

FIG. 5 illustrates the forces acting on a vehicle that may be used in a force balance model;

FIG. 6 is a flow chart illustrating how a processor may estimate a total energy consumption of a vehicle;

FIG. 7 is a schematic representation of an apparatus for performing the method as described in relation to FIG. 1;

FIG. 8 is a schematic representation of a vehicle comprising an embodiment of the apparatus of FIG. 7; and

FIGS. 9a to 9h show schematic views of various user interfaces.

### DETAILED DESCRIPTION OF THE EMBODIMENTS

The present disclosure relates to an apparatus and method for determining the compatibility of one or more electric vehicles with a user's usage pattern. More particularly, the apparatus receives information relating to journeys taken by the user and processes this information to determine projected operating factors of the one or more electric vehicles if those vehicles were to be used on these journeys. The operating factors may be used to indicate suitability of those electric vehicles to the user's lifestyle or routine.

In the described embodiments, the apparatus receives sensor data relating to one or more journeys taken in a vehicle, such as the user's current vehicle. For example, the user's current vehicle may be powered entirely or predominantly via an internal combustion engine, such as a petrol or diesel engine. The sensor data obtained during journeys taken in the user's current vehicle is then processed to provide a ‘virtual ownership experience’ of one or more other vehicles that is personal to their own usage routine.

The embodiments described herein may provide a virtual ownership experience of one or more electric vehicles and so may be used to assess the suitability of such vehicles to a user who has little or no experience of electric vehicles. The user can therefore be confident that information relevant to their lifestyle has been taken into consideration, for example whether the user normally takes long or short journeys, their style of driving and whether the area in which they live and work has sufficient charging points.

It will be appreciated that the apparatus and method described herein may be applied to provide a virtual ownership experience of a variety of different vehicles including, but not restricted to, battery electric vehicles (BEVs), plug-in hybrid electric vehicles (PHEVs), mild hybrid electric vehicles (MHEVs) and the like. For simplicity, the remaining disclosure will refer to ‘electric vehicles’ which is intended to include all of the above mentioned electric and hybrid electric vehicle types. However, it will be appreciated that the present invention may also be applied to provide a virtual ownership experience of any type of vehicle, electric or otherwise.

In the context of the present invention, a virtual ownership experience provides an indication of operating factors, in particular charging requirements, for the one or more electric vehicles. These operating factors will be particularly useful to users of petrol or diesel vehicles who may have little or no practical knowledge of vehicle battery charging and the associated issues. Lack of knowledge in these factors may lead to hesitancy to switch to an electric vehicle despite a user's desire to reduce their environmental impact.

The charging requirements of a vehicle may include indicators of how often the electric vehicle would need to be charged, how long each charge event would be required to last to provide sufficient charge for the user's usual journeys and the location of relevant charging stations that may be used by the user. Other operating factors relating to the running and maintenance of the electric vehicle may also be indicated.

Although embodiments of the invention are described in relation to a single user, it will be appreciated that the present invention may be applied to a plurality of users of a vehicle, for example a family car with multiple users. A user may be, for example, a driver of vehicles and/or a passenger of vehicles.

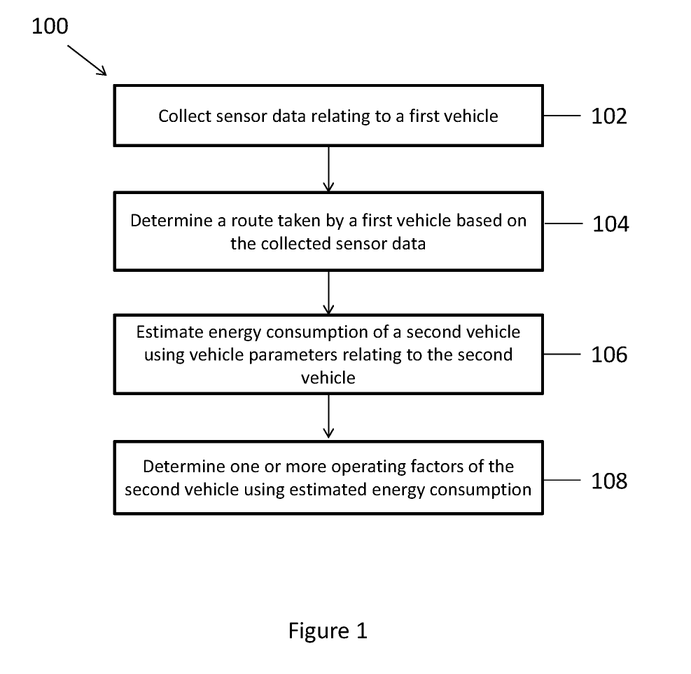

FIG. 1 is a flowchart that illustrates a method 100 for determining the compatibility of an electric vehicle with a user's current usage pattern in accordance with an embodiment of the invention.

Firstly, sensor data relating to a first vehicle is collected at step 102. For example, the first vehicle may be the user's current vehicle. In embodiments, the sensor data may relate to position data received from one or more sensors, for example a Global Positioning System (GPS) device or system such as a GPS chip. The position data may be derived from Global Navigation Satellite System (GNSS) data, such as GPS data, received at the one or more sensors and each received position data point includes at least a location associated with the first vehicle. In general, a number of temporally spaced apart GNSS data points may be received at the one or more sensors. The GNSS data points need not be equally spaced. However, in embodiments the received GNSS data points may be spaced apart by equal times, for example, a GNSS data point may be received at the one or more sensors every second, although other frequencies may be chosen depending on detection and processing requirements, for example.

It will be appreciated that additional or alternative sensor data may be used including accelerometer data, and/or data received from a gyroscope and/or an inertial measurement unit (IMU), for example.

The sensor data is collected during at least one journey taken by a user in the first vehicle. In embodiments, sensor data is collected via a device present within the vehicle during the at least one journey, for example a mobile computing device, herein after referred to as a mobile device, which may be a smartphone, tablet, laptop or other device suitable for collecting sensor data of the type mentioned above. In embodiments, the sensor data may be collected automatically when a journey is started without user input. For instance, one or more software applications provided on the mobile device may be configured to automatically initiate or ‘wake up’ when it is determined that a journey has started.

At step 104, the collected sensor data is used to determine the route taken by the first vehicle. The route may be divided into segments according to the collected sensor data. The sensor data may be processed, on the mobile device and/or remotely therefrom on a server, as will be described in more detail below.

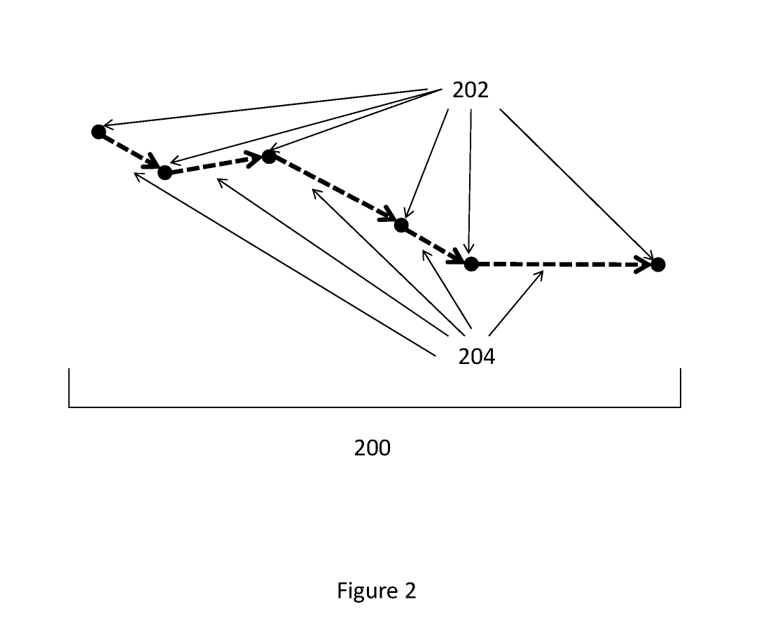

FIG. 2 illustrates one particular method for determining the route taken by the first vehicle. More particularly, FIG. 2 illustrates, schematically, a route 200 which may be followed by the first vehicle as reconstructed from sensor data in the form of position data points 202 collected by the one or more sensors. Each position data point 202 may be used to derive a location of the first vehicle at a particular time. In this way, the position data points 202 can be used to define route segments 204 which correspond to a route taken between contiguous received position data points 202.

In embodiments, altitude data relating to each location may also be derived from the position data points 202, and the route segments 204 may therefore include information relating to the slope between adjacent or contiguous position data points 202. Additionally or alternatively, altitude information stored within map data may be retrieved for each derived location.

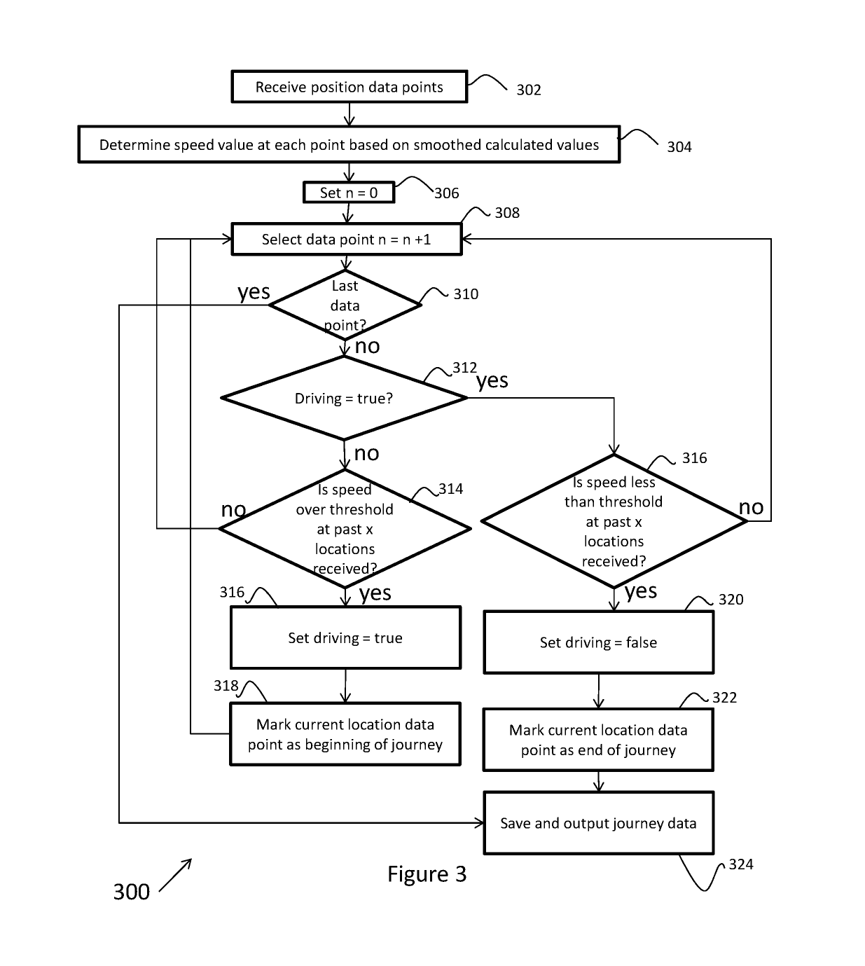

In order to determine the route 200 taken by the first vehicle, the steps shown by the process flow chart 300 of FIG. 3 may be carried out by one or more processors. The one or more processors may comprise a processor(s) located on a remote server. In an embodiment, these steps may instead be carried out by one or more processors located on the mobile device. In yet further embodiments, one or more of the process steps may be carried out by a distributed system comprising both an on-board processor (i.e. on the mobile device) and an off-board processor (i.e. on the remote server). For brevity, the remaining disclosure will refer to “the processor”. However, it will be appreciated that such a reference may refer to one or both of a processor located on the mobile device and/or a processor located on a remote server.

In the illustrated embodiment, the process begins at step 302 in which the position data points 202 are received by the processor from the one or more sensors. In alternative embodiments, sensor data may be sent directly from the sensors to the processor and the processor may be configured to derive locations of the vehicle at particular times from the sensor data.

The position data points 202 may be uploaded to the processor periodically. For example, position data points 202 for a journey may be uploaded at the end of the journey or alternatively may be uploaded in real time.

The received position data points 202 may be stored in memory, for example located on a server. At step 304 a speed value is determined for each location defined by a position data point 202, based on smoothed values of the position data points 202. The smoothing of locations determined by received position data points 202 will be described in more detail in the ensuing description.

The received position data points 202 may be labelled in the order in which they are received. Step 306 sets n=0, where n is the number of a position data point. At step 308 the data point n=n+1 is selected, such that the position data points 202 are processed in order of being received by the processor. On the first iteration of the process flow chart, the first position data point 202, having label n=1 is selected.

It is then queried whether the position data point 202 is the last position data point 202 at step 310. If the position data point 202 is the last position data point 202, the process proceeds to save and output the route data at step 324. If the position data point 202 is not the last position data point 202, the process instead proceeds to step 312 in which it is queried whether the first vehicle is moving by determining whether a variable, driving=true. Initially it is assumed that driving=false, i.e. that the mobile device is not within a moving vehicle.

The processor determines whether the mobile device is within a moving vehicle by determining the speed of the mobile device. If this speed is over a certain threshold for a certain period of time, the mobile device is determined to be within a moving vehicle.

At step 314 it is determined whether the speed determined from the received position data points 202 has been above a threshold speed for a certain number of position data points 202. For example, in a specific embodiment if the mobile device is determined to be moving at 30 mph for the past 10 seconds (which may correspond to 10 received position data points 202), the mobile device may be considered to be within a moving vehicle and it may therefore be assumed that the first vehicle is following a route 200.

If it is determined that the mobile device has not been above the threshold speed for a certain number of position data points 202, the process returns to step 308 in which the subsequent position data point 202 is selected to undergo the analysis outlined above.

If it is determined that the mobile device has been travelling above the threshold speed for a certain number of position data points 202, the process proceeds to step 316 in which the variable driving is set to equal “true” i.e. the user is determined to be travelling in the first vehicle. The position data point 202 is then marked as the beginning of the route 200 at step 318.

The process returns to step 308 in which the subsequent position data point 202 is selected. Provided that at step 310 the position data point 202 is not found to be the last data point, at step 312 it is now determined that driving does equal “true” and the process proceeds to step 316. At step 316 it is determined whether the determined speed at each position data point 202 has been below the threshold speed for a certain number of position data points 202. This step aims to determine whether the route has ended as the mobile device is no longer moving at a speed consistent with the speed of a moving vehicle. The certain number of position data points 202 allows for, for example, the first vehicle to be in traffic or to have stopped at traffic lights, whilst still being counted as a part of the same route 200 by the processor.

If the speed is determined to have not been below the threshold speed for a certain number of position data points 202, the process again returns to step 308 and the subsequent position data point 202 is selected. If however the speed is determined to be below the threshold, the process proceeds to step 320 in which the variable driving is set as being “false”, i.e. the mobile device is determined to not be within a moving vehicle. The current position data point 202 is set as the end of the route 200 at step 322.

At step 324 the route information is then saved and output for further processing as will be described in greater detail below.

In an embodiment, the process of determining the beginning and end of a route may be carried out in real time as each position data point 202 is received by the processor.

In an embodiment, there may be a step (not shown) in which it is determined whether the number of position data points 202 making up the route 200 is above a minimum number of position data points 202.

The calculated route data may then be used to determine motion data of the first vehicle at each route segment 204. The received position data points 202 may be used to determine the distance travelled by the first vehicle and the speed, acceleration and altitude of the first vehicle at each position data point 202.

Referring back to FIG. 1, the next step 106 of the method comprises correlating the route data with one or more vehicle parameters relating to a second vehicle (e.g. an electric vehicle) to determine an estimated or predicted energy consumption of the second vehicle using a force balance model. The estimated energy consumption of the second vehicle is an estimation of the amount of energy that would have been used by the second vehicle if the second vehicle had taken the same journey(s) as taken by the first vehicle.

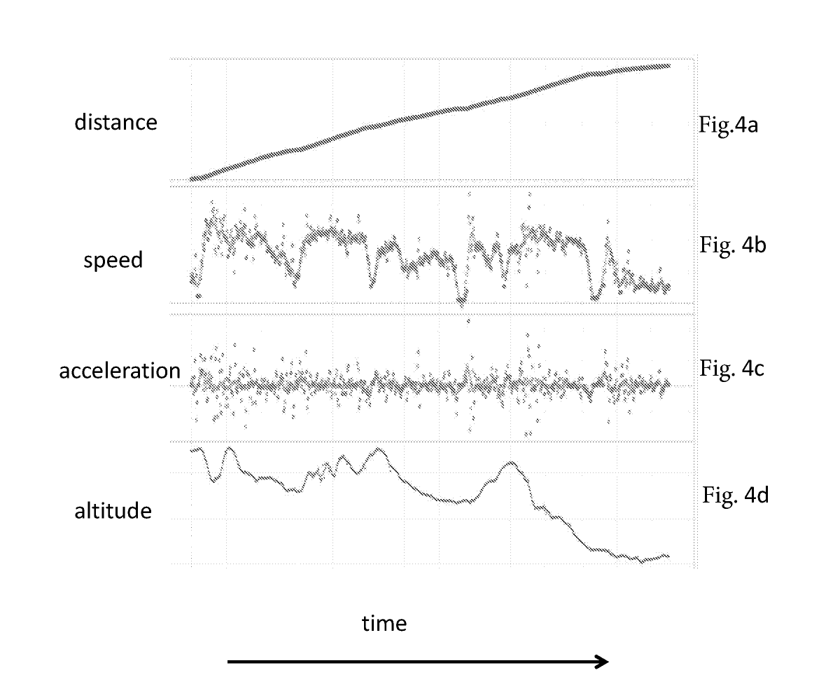

An example method of determining the estimated energy consumption of the second vehicle in accordance with an embodiment is illustrated in FIGS. 4-6.

FIGS. 4a-4d, for example, show graphs displaying motion data relating to the first vehicle for a first route 200.

FIG. 4a is a graph of cumulative distance travelled by the first vehicle with respect to time. The cumulative distance may be determined directly from the position data points 202, each point having a corresponding time. The distance travelled for each route segment 204 may therefore be determined by calculating the distance between locations at consecutive position data points 202. The cumulative distance may then be plotted against the time at which each position data point 202 was received. The resulting data points may be smoothed.

In embodiments, the smoothing of position data points 202 may be achieved via applying a Savitzky-Golay filter (also referred to as “Savgol smoothing”) to the set of position data points 202. It will be appreciated that other methods of data smoothing may be used additionally or alternatively.

To then determine the speed of the first vehicle at each route segment 204, a differential of the smoothed plot of FIG. 4a may be obtained to produce FIG. 4b, which illustrates a speed profile of the first vehicle comprising a series of speed data points plotted with respect to time. The speed profile may similarly have a smoothing algorithm applied to it.

FIG. 4c shows the acceleration profile of the first vehicle comprising a series of acceleration data points plotted with respect to time. The plot shown in FIG. 4c may be produced through obtaining a differential of the speed profile of FIG. 4b with respect to time. Again, the acceleration profile may be smoothed by applying a smoothing algorithm to the acceleration data points.

FIG. 4d shows an altitude profile comprising a series of altitude data points corresponding to the altitude of the first vehicle over time. As described above, the altitude of the first vehicle may be determined by the processor from the position data points 202, e.g. by retrieving altitude data from a map database for each determined location. Alternatively, the position data points 202 received by the processor from the one or more sensors may comprise the altitude data points. Smoothing may also be carried out on the altitude data.

The motion data for the first vehicle is then used to estimate the forces acting on the second vehicle were the second vehicle taking the route 200 taken by the first vehicle.

A force balance model is used to determine the forces acting on the second vehicle for each route segment 204 using the above calculated speed, acceleration and altitude/slope values for each route segment 204. The force balance model determines at least one force acting on the second vehicle wherein the at least one force may be one or more of an acceleration force, a drag force, a rolling force and an inertial force.

In order to estimate the forces on a second vehicle taking a route 200, certain predetermined vehicle parameters corresponding to the second vehicle may be used. The predetermined vehicle parameters may include at least the mass of the vehicle, a coefficient of resistance of the tyres on the road surface, a drag coefficient of the vehicle and a cross-sectional area of the second vehicle. The second vehicle parameters may be stored on a remote server and/or on the mobile device, for example.

Vehicle parameters may be available for a range of vehicles, for example a range of different electric vehicles in order to enable the determination of which electric vehicle may be most suited to a particular user.

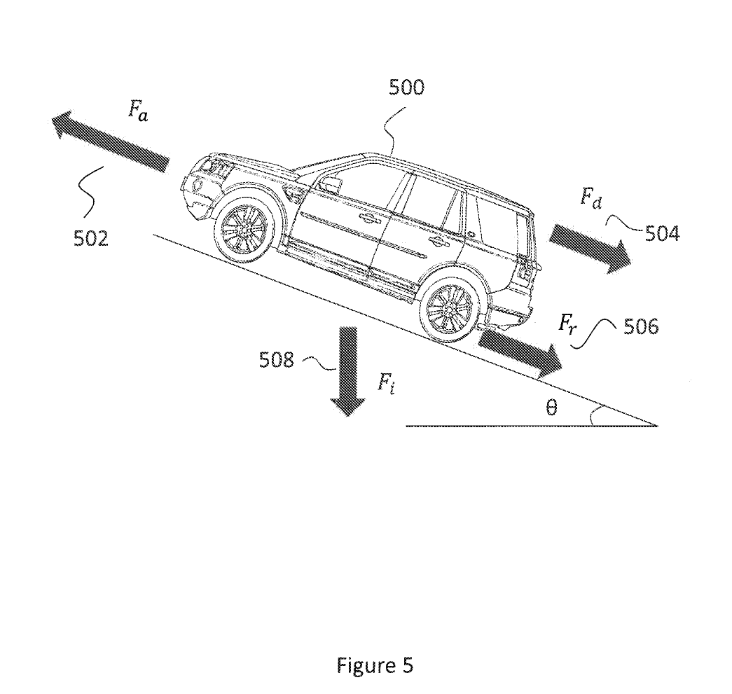

FIG. 5 shows a schematic illustration of the forces acting on the second vehicle 500 for a route segment 204. The second vehicle 500 is shown to be driving up a slope, the slope being angled at an angle θ from the horizontal. The slope may be determined for each route segment 204 using the difference in distance between consecutive position data points 202 and the difference in altitude between consecutive position data points 202.

The forces on the second vehicle 500 for each route segment are estimated using the force balance model which may take into account, at least, an acceleration force 502, a drag force 504, a rolling force 506 and an inertial force 508 acting on the second vehicle 500.

The force 502 on the second vehicle 500 due to the acceleration of the second vehicle 500 may be determined by the following equation:

Fₐ=m*a (Equation 1)

where Fₐ is the acceleration force 502, m is the mass of the second vehicle 500 and a is the acceleration of the second vehicle 500 as calculated for the route segment 204.

The drag force 504 on the second vehicle 500 due to air resistance may be calculated by the following equation:

F_{d}=0.5*ρ*C_{d}*A_{f}*v² (Equation 2)

where F_{d} is the drag force 504 acting on the second vehicle 500, ρ is the density of air, C_{d} is the drag coefficient of the second vehicle 500, A_{f} is the front cross-sectional area of the second vehicle 500 and v is the speed of the second vehicle 500 as determined for the route segment 204.

The rolling force 506 acting on the second vehicle 500 due to the interaction between the tyres and the road surface may be calculated by the following equation:

Fᵣ=m*g*Cᵣ*cos(θ) (Equation 3)

where Fᵣ is the rolling force 506 on the second vehicle 500, m is the mass of the second vehicle 500, g is acceleration due to gravity, Cᵣ is the rolling coefficient of the second vehicle 500 and θ is the angle of the slope from the horizontal.

The inertial force 508 acting on the second vehicle 500 due to the effects of gravity may be determined by the following equation:

Fᵢ=m*g*sin(θ) (Equation 4)

where Fᵢ is the inertial force 508 acting on the second vehicle 500, m is the mass of the second vehicle 500, g is the acceleration due to gravity and θ is the angle of the slope from the horizontal.

In an embodiment, the total force exerted by the second vehicle 500 for each route segment 204 in order to provide the observed motion may be assumed to be provided by the prime mover (i.e. electric motor and/or engine) and/or a braking system of the second vehicle 500. The total force for each route segment 204 may then be calculated as follows:

F_{segment}=Fₐ+F_{d}+Fᵣ+Fᵢ (Equation 5)

where F_{segment} is the total force supplied by the prime mover and/or braking system of the second vehicle 500 for the route segment 204.

The force supplied by the prime mover and/or braking system of the second vehicle 500 for each route segment 204 may then be used to estimate the energy consumption of the prime mover and/or braking system of the second vehicle 500 for the route segment 204 using the following relation:

E_{segment}=F_{segment}*v*Δt (Equation 6)

Where E_{segment} is the energy consumption of the prime mover and/or braking system of the second vehicle 500 for the route segment 204, F_{segment} is the force provided by the prime mover or braking system of the second vehicle 500 for the route segment 204, v is the estimated velocity of the first and therefore second vehicle 500 for the route segment and Δt is the time between subsequent received position data points 202 defining the beginning and end of the route segment 204.

The total predicted energy consumption of the prime mover and/or braking system of the second vehicle 500 for the total route 200 determined to have been taken by the first vehicle may therefore be determined by summing the predicted energy consumption of the prime mover and/or braking system of the second vehicle 500 for each route segment 204.

In addition to the energy consumption estimated via use of the force balance model, additional factors may be taken into account within the calculations carried out by the processor in order to provide a more accurate estimate of the second vehicle's 500 energy consumption.

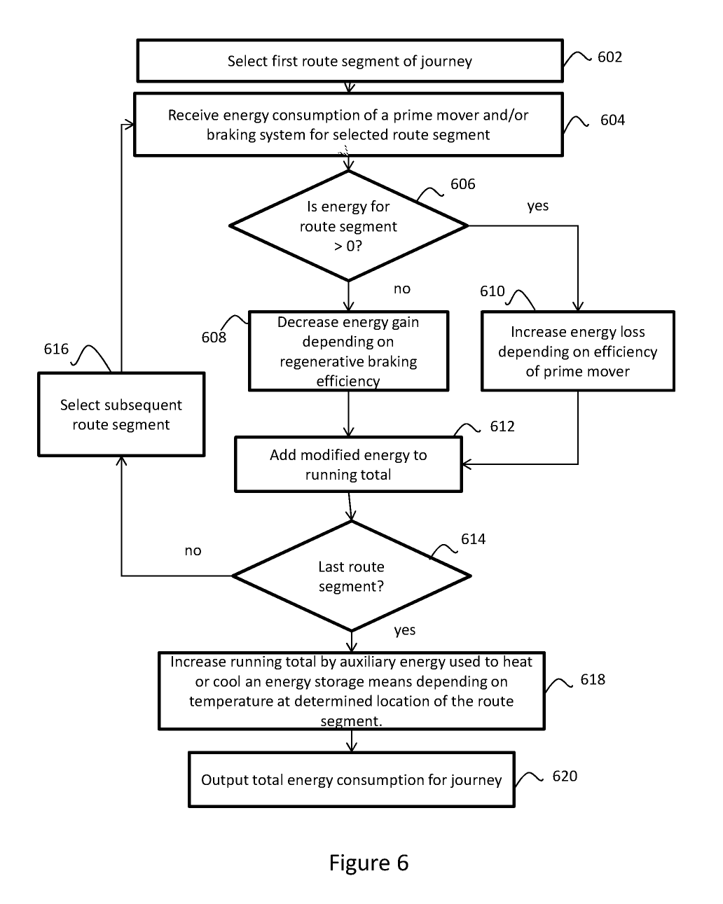

FIG. 6 is a process flow chart showing how the processor may compute an estimate for the total energy consumption of the second vehicle 500 for the route 200 in accordance with an embodiment.

The process begins at step 602 in which the first determined route segment 204 for the route 200 is selected. Then, at step 604, the estimated energy consumption of the prime mover and/or braking system of the second vehicle 500 for the route segment 204, as calculated by the force balance model, is received.

At step 606 it is queried whether the energy consumption for the route segment 204 is greater than zero. Within the calculation of energy consumption the determined energy consumption may be either positive, corresponding to energy lost, or negative, corresponding to energy gained. For example, the determined energy consumption may be positive due to the vehicle being powered by the prime mover.

For some electric vehicles, energy may be regained during braking due to regenerative braking, in which the kinetic energy from the wheels of the vehicle is used to charge a vehicle energy storage means.

For example, when a vehicle is braking during a particular route segment 204, the determined acceleration is negative and therefore the acceleration force on the vehicle is also negative as it is directly proportional to the acceleration. The energy consumption of the prime mover and/or braking system calculated for the route segment 204 may therefore be determined to be a negative value, which corresponds to the vehicle regaining energy through regenerative braking.

At step 606 if the energy consumption for the route segment 204 is determined to be less than zero, the process proceeds to step 608 during which the energy gain is decreased depending on the efficiency of the regenerative braking.

In an embodiment, the regenerative braking may be assumed to work with a certain efficiency and the determined energy gain for the route segment 204 may therefore be multiplied by this efficiency. In a specific example, the regenerative braking efficiency may be around 15%. The modified energy gain for the route segment 204 is therefore less than the original energy gain for the route segment 204.

If at step 606 the energy consumption for the route segment 204 is instead determined to be greater than zero, the process proceeds to step 610. At step 610 the estimated energy loss for the route segment 204 is increased depending on the efficiency of the second vehicle prime mover. The estimated energy loss may be divided by the efficiency in order to arrive at a more accurate estimate. In a specific example, the prime mover efficiency may be around 83% in the case where the prime mover is a vehicle motor.

From either step 608 or 610, the process proceeds to step 612 at which the modified energy gain or energy loss is added to a cumulative total relating to all route segments 204. The total energy for the route 200 may therefore be later determined from this cumulative total.

The process then proceeds to step 614 in which it is queried whether the route segment 204 is the last route segment 204 of the route 200. If the route segment 204 is not the last route segment 204, the process proceeds to step 616 in which the subsequent route segment 204 is selected. The process then returns to step 604 and repeats the above process for the subsequent route segment 204.

If at step 614 it is determined that the route segment 204 is the last route segment 204, such that the energy consumption data has been modified and summed for every route segment 204 comprised within the route 200, the process proceeds to step 618.

At step 618, the running total energy consumption is increased by the auxiliary energy used to heat or cool an energy storage means of the second vehicle 500, such as a battery of the second vehicle 500, for example.

An electric vehicle energy storage means may work most efficiently within a small temperature range and its performance may drop off at lower temperature. Therefore often the energy storage means may be heated or cooled to the temperature at which it works most efficiently.

To estimate the energy used to heat or cool the energy storage means, it may be determined by how much the external temperature varies from the optimum temperature for performance of the energy storage means. In an embodiment, the auxiliary drain rate may be assumed to be proportional to the deviation of the external temperature from the optimum temperature. The auxiliary drain rate may be multiplied by the duration of the journey in order to determine the total auxiliary drain.

In an embodiment, the external temperature may be an average temperature which is determined based on information such as the month of the year and the country or region in which the driver lives. This information may already be stored and called upon when required within the calculation.

In another embodiment, an average location may be determined for the journey and this location may be used to determine a current temperature for the location. In an embodiment, the current temperature may be determined via a weather application installed on the mobile device.

Once the determined auxiliary energy used to heat or cool the energy storage means has been added to the total estimated energy consumption of the second vehicle 500, the process proceeds to step 620 at which the total energy consumption for the journey is output.

Referring back to FIG. 1, the method steps 104 and 106 may be repeated a plurality of times for a plurality of routes 200 taken in the first vehicle. For example, the estimated energy consumption over a particular period of time, for example one day and/or one week, may be cumulated to provide a ‘routine energy consumption’ for that period of time. Furthermore, the routine energy consumption may be stored for a plurality of such periods and an average taken. For example, an average daily energy consumption and/or average weekly energy consumption may be calculated from the cumulated estimated energy consumption data.

At step 108, the estimated energy consumption and/or routine energy consumption is then used to determine one or more operating factors associated with using the second vehicle. In particular, operating factors may relate to charging requirements of the second vehicle. In embodiments, the charging requirements are additionally correlated with data relating to a local or regional charging infrastructure.

The charging requirements of the second vehicle are then communicated to the user, for example via a user interface. In embodiments the user interface is an application on a mobile device, particularly where the mobile device has also been used to receive the sensor data. It will be appreciated that the user interface may also be on a different mobile device or computer or may be on a display screen comprised within the first vehicle.

Energy consumption data relating to a second vehicle 500 may therefore be used to determine the suitability of the second vehicle 500 for the user based on their driving style or routine.

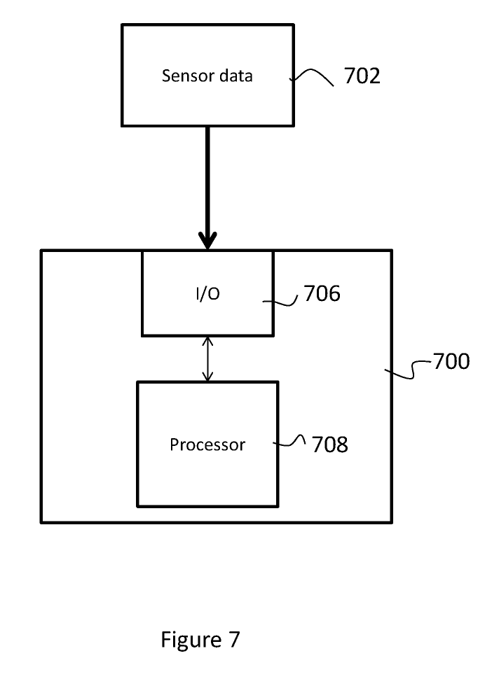

FIG. 7 shows, schematically, an example apparatus 700 in accordance with an embodiment for performing the method as described in relation to FIG. 1. The apparatus includes an input/output 706 for receiving sensor data 702 from one or more sensors, for example sensors configured to received GNSS data from one or more GNSS satellites. In embodiments, the one or more sensors are comprised in a mobile device. More generally, the sensors may be comprised in any device that may be transported within a first vehicle in order to capture data relating to one or more routes 200 taken by the first vehicle. Alternatively, the sensors may be incorporated in the first vehicle and communicatively coupled to the input/output 706 of the apparatus.

The apparatus 700 additionally comprises a processor 708 configured to use the sensor data 702 to determine information indicative of a virtual ownership experience of a second vehicle 500. More particularly, the processor 708 is configured to determine an estimated energy consumption of the second vehicle 500 based on the received sensor data 702. The processor 708 may be additionally configured to determine at least one charging requirement of the second vehicle 500 in dependence on the estimated energy consumption.

The one or more sensors are configured to determine the position of the first vehicle at a given time. For example, the one or more sensors may be configured to receive GNSS data from a GNSS (for example, GNSS data corresponding to the position of one or more satellites of the GNSS) and transmit that data to the apparatus 700, the apparatus 700 being configured to determine position data for the first vehicle in dependence on the received sensor data 702, the position data corresponding to the location of the first vehicle at a given point in time. As described above, in alternative arrangements, the received sensor data 702 may comprise position data corresponding to the location of the first vehicle at a given point in time derived separately to the apparatus 700.

The apparatus 700 may be comprised in a single device, such as a mobile computing device or may be comprised within two or more separate devices such as a mobile computing device and remote server. Although a single processor 708 is shown in FIG. 7, it will be appreciated that the apparatus may include more than one processor 708 and that the processors may be remote from each other. For example, the one or more processors may comprise a first processor forming part of mobile device and a second processor forming part of a remote server.

The processor 708 may be further configured to communicate the information indicative of a virtual ownership experience, including the at least one charging requirement, to the vehicle user. The information may be displayed to the user via a user interface.

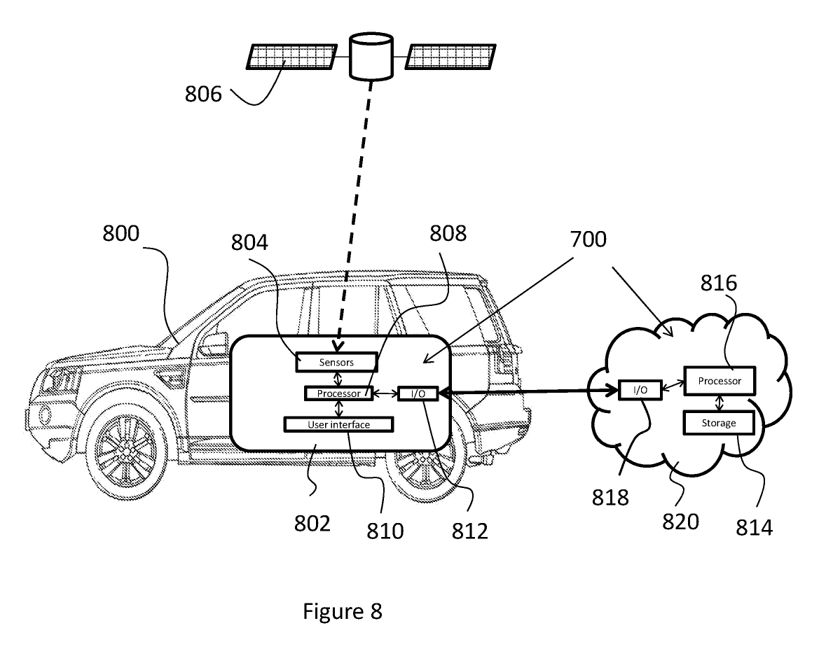

FIG. 8 shows an example arrangement including the apparatus 700 of FIG. 7. The arrangement includes a first vehicle 800 in which a user may make one or more journeys, sensors 804 for receiving GNSS data from one or more satellites 806 and an apparatus 700 for calculating an estimated energy usage of a second vehicle 500 (not shown within FIG. 8) in dependence on the received GNSS data in accordance with the above described methods. In an embodiment the apparatus 700 may also determine the suitability of a second vehicle 500 in dependence on the vehicle user's current usage pattern based on the one or more journeys.

The apparatus 700 is comprised on a mobile device 802, e.g. in the form of a smartphone and a remote server 820 which is in communication with the mobile device 802.

The mobile device 802 comprises one or more sensors 804 configured to receive GNSS data from GNSS satellites, for example GPS satellites 806. In this way, whilst the first vehicle 800 is travelling a given route, the mobile device 802 receives GNSS data corresponding to the location of the first vehicle 800 along the route 200. The mobile device 802 further includes a processor 808 configured to receive sensor data 702 from the one or more sensors 804 and transmit information indicative of a virtual ownership experience of the second vehicle 500 to a user interface (UI) 810 in the form of a smartphone screen.

The sensors 804 of the mobile device 802 are shown to receive GNSS data which may contain information from which the processor 808 may be able to determine the location of the mobile device 802, and hence the first vehicle 800 at any given time. In an embodiment, the GNSS data may additionally be used to determine information relating to the altitude of the mobile device 808, and hence the first vehicle 800, at given location.

The mobile device 802 further includes an input/output 812 via which it communicates with the remote server 820.

The remote server 820 comprises an input/output 818 via which it may communicate with the mobile device 802 via the input/output 812 of the mobile device 802. In general, the processor 808 and the remote server 820 may communicate via any suitable method.

The remote server 820 additionally comprises storage 814 configured to store information relating to the second vehicle 500. For example, the storage 814 may store one or more predetermined parameters of the second vehicle 500. The one or more parameters may include energy storage means data, vehicle mass or other performance related parameters. The mobile processor 808 may be configured to determine the predicted energy consumption of the second vehicle 500 in dependence on the one or more predetermined parameters of the second vehicle 500, as described in relation to FIGS. 4 to 6 above.

In the illustrated embodiment, the remote server 820 additionally comprises a server processor 816. The server processor 816 may be configured to determine a predicted energy consumption of the second vehicle using a force balance model, one or more predetermined parameters of the second vehicle, as described in relation to FIGS. 4-6 above, and position data relating to the location and altitude of the first vehicle 800 at a given time along a route as derived by the mobile processor 808.

In an alternative embodiment, the determination of a predicted energy consumption of the second vehicle 500 may instead be carried out on the mobile processor 808.

In embodiments, the server processor 816 is configured to receive route data relating to a plurality of routes 200 taken by the first vehicle 800 and select a suitable second vehicle 500 from one of a plurality of second vehicles 500 for which predetermined parameters are stored in dependence on the route data. The server processor 816 may then request information relating to that second vehicle 500 for use in the energy estimation and communicate that information with the mobile processor 808 for use with energy estimation software which may be installed on the mobile device 802.

In such embodiments, the server processor 816 may then determine a predicted energy consumption of the second vehicle 500 using the sensor data 702, the force balance model and the one or more predetermined parameters.

The mobile processor 808 may further be configured to generate for display one or more outputs including, at least, a charging requirement of the second vehicle 500 based on the predicted energy consumption.

Possible outputs include how often the second vehicle 500 would need to be charged at a charging station, how long each charging event may last and the location of one or more preferred charging stations. The preferred charging stations may be charging stations determined as most convenient for the user such as those located at or near to locations in which the first vehicle 800 remains stationary for a predetermined period of time (e.g. when the first vehicle 800 is parked at a user's home or work address). In embodiments, the mobile processor 808 may be configured to receive a user input indicative of a location of a charging station, or a proposed location of a charging station, e.g. where a user may be considering installing a charging station were they to purchase an electric vehicle.

For example, the mobile processor 808 may be configured to output (to the user) information relating to typical charging locations, the number of times charging is required per week or month to complete the total distance in dependence on the determined energy consumption profile of the user, the number of times charging is required during the day due to inability to cover all distance within a single charge, running electricity cost based on an average energy price and weekly/monthly distance and energy consumed.

As such the apparatus 700 of the invention may be configured to receive stored information relating to local charging stations, for example a national or regional network of charging stations. This information may be stored on the mobile device 802 or may be stored on the server 820 for access by the one or more processors 808, 816.

Additional outputs may include information relating to a user profile of the user. For example, the total distance travelled in the first vehicle 800, distance travelled in the last week and/or day and average values relating to distance travelled e.g. average distance travelled per week and/or day in the first vehicle 800.

Additionally or alternatively, the output may include information relating to frequent parking locations of the first vehicle 800. In embodiments, the frequent parking locations may be equated to the home and/or work place of the user. For example, the processors 808, 816 may detect two locations in which the first vehicle 800 is most frequently parked. Of those two locations, the one in which the first vehicle 800 is most frequently parked overnight may be labelled as ‘home’ and the other location ‘work’. The apparatus may be configured such that the user may verify and/or amend the ‘home’ or ‘work’ locations.

The home or work locations may be used to determine the one or more preferred charging stations. For example, at least one of the processors 808, 816 may receive information relating to local charging stations and select one or more charging stations within a predetermined radius of the home or work locations. For example, the processors 808, 816 may select one or more charging stations within a 1 km radius of the home and/or work locations. Additionally or alternatively the processors 808, 816 may select the closest charging station to the home or work locations. The apparatus may be configured such that the user can input a desired radius of the home or work locations. Additionally or alternatively, and as described above, the mobile processor 808 may be configured to receive a user input indicative of a location of a charging station, or a proposed location of a charging station, e.g. where a user may be considering installing a charging station were they to purchase an electric vehicle.

The processors 808, 816 may also use information relating to additional frequent parking locations of the first vehicle 800 in which the first vehicle 800 frequently parked for sufficient time for a charge event to occur. Such additional parking locations may include, for example, a car park or a friend or relative's home.

The user interface 810 is configured to display information relating to the outputs from the application to the driver to provide a virtual ownership experience of the second vehicle 500.

The user interface 810 may additionally enable a user to input information manually for use by the processors 808, 816 to calculate energy consumption and/or provide the operating factors.

The user interface 810 may additionally allow the user to select a particular second vehicle 500 with which to have a virtual ownership experience. In particular embodiments, the apparatus 700 may generate a selection of second vehicles 500 from which the user may choose one with which to have a virtual ownership experience. For example, the apparatus may determine that there are four different types of second vehicle 500 which may suitable for use by the user based on the determined energy consumption profile for the vehicles, the user's routine and lifestyle. The user interface 810 may present information relating to each of the four second vehicles 500 from which the user can select one or more therefrom. The information relating to the vehicles may include the vehicle's price, its maximum range, average charge time, rated power, the time it takes to reach a given speed, the number of passenger seats in the vehicle, the storage volume of the vehicle, a picture of the vehicle and any other information which may inform the user to choose between the vehicles. The user interface 810 may provide a link to access information on a vehicle product web page.

The average charge time for a given vehicle may also be dependent on the type of charger used/available for use at any of the given charging locations. Therefore, the information relating to the vehicles may include various charge times dependent on various types of chargers. In embodiments, the apparatus 700 may be configured to determine which types of chargers may be available for use by the user based on the determined routine, and output information relating to the average charge time for a given vehicle in dependence thereon.

Determination of suitability of the vehicles from which the user may select may be in dependence on energy consumption and/or may be in dependence on availability of those vehicles in the country or region of the user.

The apparatus 700 may be configured to receive position data for a particular period of time before compiling the data and generating the results. For example, the apparatus 700 may be configured to have a minimum ‘learning’ period in which it receives and processes data relating to journeys taken by the user in the first vehicle 800. Virtual ownership information may be unavailable during the ‘learning’ period in order to prevent inaccuracies due to anomalous data, for example.

Once a particular second vehicle 500 is selected, the processors 808, 816 may select the corresponding energy storage means performance data and assimilate this with the energy consumption data to provide a virtual ownership data relating to that vehicle.

In the illustrated embodiment, the apparatus 700 includes a mobile processor 808 comprised in the mobile device 802 and a server processor 816 comprised in the remote server 820. However it will be appreciated that other configurations may be used within the scope of the present invention. For example, one or more processors for executing the invention may be comprised in the mobile device 802. Alternatively, the one or more processors may be comprised in the remote server 820 such that the determination of the energy consumption and charging requirement of the second vehicle 500 is solely performed on the remote server 820. For example, the apparatus may comprise a means for communicating sensor data 702 with the remote server 820 comprising the remote processor 816. In embodiments, the apparatus 700 may be configured to perform some or all of the processing of the sensor data 702. For example, the apparatus for receiving sensor data may be comprised within the first vehicle 800, for example as part of an on-board computing means of the first vehicle 800.

Although the methods described above use GPS data, it will be appreciated that other GNSS location data such as GLONASS, Galileo, BDS, NAVIC or QZSS data could be used additionally or alternatively.

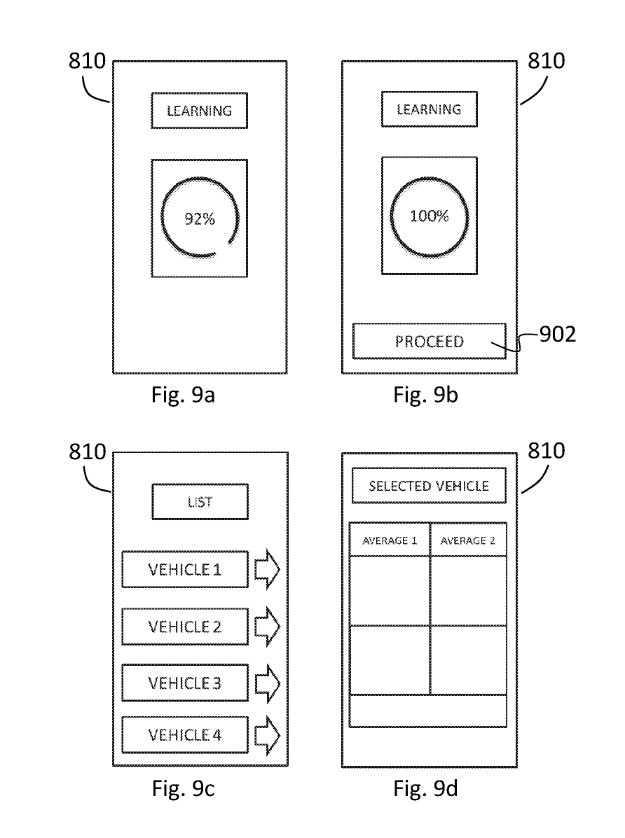

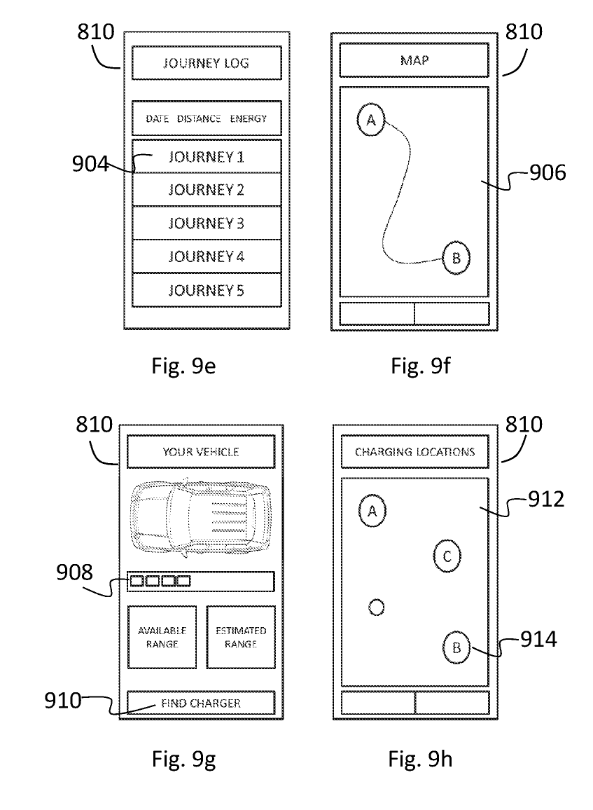

FIGS. 9a-9f show schematic views of the various user interfaces 810 that may be displayed to the user during implementation of the method 100 of FIG. 1 as described above. The views may be an output of a mobile application, for example, accessible on the mobile device 802.

FIG. 9a shows an example view for communicating a learning phase of the application. For example, while the processor is receiving and assimilating sensor data 702 to generate a routine energy profile of the user as described in relation to FIG. 1 above. When sufficient data has been received and a routine energy profile has been generated, the application may display an output such as that shown in FIG. 9b to indicate that it is now possible to review results relating to a virtual ownership experience. In the embodiment shown in FIG. 9b, a button 902, for example a touch screen button, is displayed and must be pressed to view the next stage of the process.

FIG. 9c shows an example view of four electric vehicles that are considered suitable for the user, based on energy usage and/or regional availability for the user. The user may need to select a preferred one of the electric vehicles for which the virtual ownership experience will be generated. Information which may assist the user in selecting one of the vehicles is also displayed. For example, an image of the vehicles, price, maximum battery life, power rating and charge time are shown although it will be appreciated that other vehicle properties may be displayed additionally or alternatively.

Once a preferred one of the electric vehicles has been selected, data indicative of a virtual ownership experience may be displayed as shown in FIG. 9d. In the illustrated embodiment information relating to charging requirement may be displayed. More particularly, weekly statistics relating to the number of charges, time charged, energy used and estimated charging cost are displayed. Additionally, information relating to the users journeys, for example the longest journey taken by the user, may be displayed alongside the charging requirements.

The application may be configured such that the user can amend or delete journeys recorded by the application during the learning phase. For example, if the user took an anomalous journey or if a journey was recorded incorrectly, the user may be able to delete that particular journey from a journey log 904 accessible to the user, as shown in FIG. 9e, in order to improve the accuracy of the data. In particular embodiments, the user may be able to select particular journeys and view the corresponding estimated routes on a map 906 as shown in FIG. 9f in order to determine whether that journey should be deleted.

In certain embodiments, the application may be configured such that recorded journeys may be assessed in order to estimate whether a specific journey corresponds to a journey taken by public transport.

In an embodiment, the processor may determine whether a journey is likely to correspond to a journey taken by public transport via use of a mapping application installed on the mobile device 802. In a specific example, the determined locations of the start and end of the journey may be entered into the mapping application. The mapping application may then suggest potential routes which a user may take in order to travel from the start position to the end position.

The processor then uses these suggested routes to determine whether the journey recorded by the application may correspond to a journey taken via public transport.

For example, to determine whether the recorded journey may have been taken by train the processor may use data from the mapping application such as whether the suggested route sufficiently corresponds to a route followed by train lines, the distance at either end of the route from a train station and the total distance covered by the journey.

The application may highlight journeys determined to have been taken by public transport in the journey log 904 accessible to the user. Accordingly, the user may manually delete journeys taken by public transport from the journey log 904 in order to improve the accuracy of the data. In another embodiment, the application is optionally configured to automatically delete from the journey log 904 those journeys determined to have been taken by public transport in order to improve the accuracy of the data.

FIG. 9g shows an example view for providing a virtual ownership experience of an electric vehicle. The user interface displays a real-time indication of battery charge level 908 of the electric vehicle in accordance with the user's calculated routine energy consumption. In addition, an estimated range, i.e. the distance the electric vehicle could travel before re-charging based on the user's driving history, may be displayed. In the illustrated embodiment, an available range, corresponding to a manufacturers tested maximum range for the charge level, is also displayed.

The user interface of FIG. 9g also includes a button 910 that may be selected in order to determine a relevant charging station as discussed above. For example, selecting the button 910 may generate a map 912, as shown in FIG. 9h showing a plurality of relevant charging stations 914.

Many modifications may be made to the above examples without departing from the scope of the present invention as defined in the accompanying claims.

1. An apparatus for determining one or more operating factors of a second vehicle based on sensor data received relating to a plurality of journeys taken in a first vehicle, the apparatus comprising:
an input configured to receive the sensor data relating to the plurality of journeys taken in the first vehicle, the sensor data being obtained by a user device present within the first vehicle during the plurality of journeys; and
a processor configured to:
determine a predicted energy consumption of a second vehicle for each of a plurality of journeys undertaken by the first vehicle using the received sensor data;
determine a predicted routine energy consumption profile of the second vehicle from the predicted energy consumption for each of the plurality of journeys; and
generate an output for conveying the one or more operating factors indicative of a charging requirement for the second vehicle to a user, wherein the output is based on the predicted routine energy consumption profile.

2. The apparatus of claim 1, wherein the second vehicle is an electric vehicle.

3. The apparatus of claim 1, wherein the charging requirement includes how often the second vehicle would need to be charged.

4. The apparatus of claim 1, wherein the charging requirement includes how long a charge event would be required to last to provide sufficient charge in accordance with the predicted routine energy consumption.

5. The apparatus of claim 1, wherein the charging requirement includes the position of relevant charging stations.

6. The apparatus of claim 1, wherein the sensor data comprises data relating to locations of the first vehicle during each of the plurality of journeys.

7. The apparatus of claim 1, wherein the sensor data is generated by one or more sensors upon receipt of GNSS data.

8. The apparatus of claim 7, wherein the GNSS data is received automatically by the one or more sensors during the plurality of journeys.

9. A method of determining one or more operating factors of a second vehicle based on sensor data received relating to a plurality of journeys taken in a first vehicle, the method comprising:
receiving sensor data relating to a plurality of journeys of the first vehicle, the sensor data being obtained by a user device present within the first vehicle during the journeys;
determining a predicted energy consumption of a second vehicle for each of a plurality of journeys undertaken by the first vehicle using the received sensor data;
determining a predicted routine energy consumption profile of the second vehicle from the predicted energy consumption for each of the plurality of journeys; and
generating an output for conveying the one or more operating factors indicative of a charging requirement for the second vehicle to a user, wherein the output is based on the predicted routine energy consumption profile.

10. The method of claim 9, wherein the charging requirement includes how often the second vehicle would need to be charged, further wherein the charging requirement includes how long a charge event would be required to last to provide sufficient charge in accordance with the predicted routine energy consumption, and further wherein the charging requirement includes the position of relevant charging stations.

11. The method of claim 9, wherein the sensor data comprises data relating to locations of the first vehicle during each of the plurality of journeys.

12. The method of claim 9, wherein the sensor data is generated by one or more sensors upon receipt of GNSS data.

13. The method of claim 9, wherein the charging requirement is conveyed to the user on the user device, and further wherein conveying the charging requirement to the user includes at least displaying the one or more operating factors via a display comprised within the user device.

14. The method of claim 9, further comprising:
receiving position data relating to charging stations for the second vehicle; and
using the predicted routine energy consumption profile and sensor data to determine a charging profile of the second vehicle.

15. The method of claim 9, further comprising either or both storing and receiving energy storage means data associated with the second vehicle and using the energy storage means data to determine the predicted energy consumption, wherein the energy storage means associated with the second vehicle comprises at least one of the following: a battery, a fuel cell, an engine, and a fuel tank.

16. The method of claim 15, further comprising receiving temperature data associated with the plurality of journeys, wherein the energy storage means data includes temperature performance data, and further wherein temperature performance data includes predicted auxiliary energy usage for maintaining the temperature of the energy storage means at a predetermined temperature, or for either or both heating and cooling the energy storage means of the second vehicle to the predetermined temperature, and wherein the method further comprises including the determined predicted auxiliary energy usage in the predicted energy consumption of the second vehicle.

17. The method of claim 9, further comprising:
determining either or both one or more positions where the first vehicle is most frequently parked and routes along which the first vehicle most frequently travels; and
determining relevant charging stations within a driving profile area, the driving profile area being within a predetermined radius of either or both the frequently parked positions and frequently travelled routes, wherein determining the one or more positions includes receiving an input from the user.

18. A computer program product comprising instructions which, when executed by a computer, cause the computer to carry out the method of claim 9.

19. A mobile computing device having stored thereon the computer program product of claim 18.

20. A non-transitory computer-readable medium comprising instructions which, when executed by a computer, cause the computer to perform the method of claim 9.
